(19) United States
(12) Patent Application Publication
(10) Pub. No.: US 2024/0186032 A1
(43) Pub. Date: Jun. 6, 2024

(54) COMPOSITE

(71) Applicant: NITTO DENKO CORPORATION, Ibaraki-shi, Osaka (JP)

(72) Inventors: Hiromitsu MORISHITA, Ibaraki-shi, Osaka (JP); Atsushi TAKASHIMA, Ibaraki-shi, Osaka (JP)

(21) Appl. No.: 18/285,143

(22) PCT Filed: Mar. 16, 2022
(86) PCT No.: PCT/JP2022/011974

§ 371 Date: Sep. 29, 2023

(30) Foreign Application Priority Data
Mar. 30, 2021 (JP) 2021-057808

(51) Int. Cl. H01B 5/00; C09J 7/38

(52) U.S. Cl. CPC H01B 5/002; C09J 7/38; C09J 2203/326; C09J 2301/302

(57) ABSTRACT

The present invention relates to a composite that has excellent adhesion strength and favorable electrical conductivity in a longitudinal direction of the composite and 360° in a circumferential direction (directions of a Y-axis and a Z-axis) with respect to the longitudinal direction as an axis (X-axis). The composite includes an elongated adhesive body and an electrically conductive threadlike member.

### CROSS REFERENCE TO RELATED APPLICATION

This application is a National Stage of International Application No. PCT/JP2022/011974, filed on Mar. 16, 2022, which designates the United States and was published in Japan, and which is based upon and claims priority to Japanese Patent Application No. 2021-057808, filed on Mar. 30, 2021 in the Japan Patent Office. All of the aforementioned applications are hereby incorporated by reference in their entireties.

### TECHNICAL FIELD

The present invention relates to a composite.

### BACKGROUND ART

When bonding a plurality of articles in a producing process of an electric/electronic device or the like, an adhesive body such as an electrically conductive adhesive sheet or an electrically conductive adhesive tape having adhesiveness and electrical conductivity to an adherend may be used.

Various shapes are required for a portion (hereinafter, also referred to as a “region to be bonded”) where articles are bonded to each other via an adhesive body, depending on the articles to be bonded.

For example, in an electronic device such as a smartphone, there is a case where width reduction of the region to be bonded is required due to a demand for size reduction or a demand for design when articles constituting the electronic device are bonded. For example, in order to fix a cover glass of the smartphone, it is particularly required to reduce a width of the region to be bonded in order to achieve bezel-less.

Further, depending on a shape of the article to be bonded, it may be required to form the region to be bonded into a complicated shape such as a bent shape.

Meanwhile, as an electrically conductive composite in which threadlike members such as cables, electric wires, or optical fibers are bundled using an elongated adhesive body, for example, Patent Literature 1 discloses an electrically conductive composite including an elongated adhesive body and a threadlike member such as an optical fiber or an electric wire, in which a plurality of the threadlike members are attached around the adhesive body.

### CITATION LIST

### Patent Literature

Patent Literature 1: JP2020-24855A

### SUMMARY OF INVENTION

### Technical Problem

An adhesive body such as an electrically conductive adhesive sheet or an electrically conductive adhesive tape in the related art is difficult to apply to a complicated shape such as a curve, a curved surface, or unevenness, and has insufficient electrical conductivity.

In addition, in the electrically conductive composite disclosed in Patent Literature 1, no study has been made on an electrically conductive composite including an electrically conductive threadlike member that is not covered in an insulated manner. Further, Patent Literature 1 aims to attach and bundle the plurality of threadlike members around the adhesive body, and no study has been made on adhesive strength in bonding of the plurality of members.

The present invention has been completed in view of the above, and an object thereof is to provide a composite having excellent adhesion strength and favorable electrical conductivity in a longitudinal direction of the composite and 360° in a circumferential direction (directions of a Y-axis and a Z-axis) with respect to the longitudinal direction as an axis (X-axis).

### Solution to Problem

[1] A composite, including: an elongated adhesive body; and an electrically conductive threadlike member.

[2] The composite according to [1], in which the electrically conductive threadlike member is not covered in an insulated manner.

[3] The composite according to [1] or [2], in which the electrically conductive threadlike member is spirally attached onto a surface of the adhesive body.

[4] The composite according to [1] or [2], in which the adhesive body and the electrically conductive threadlike member are twisted together.

[5] The composite according to any one of [1] to [4], in which the adhesive body is threadlike.

[6] The composite according to any one of [1] to [5], in which the adhesive body includes a threadlike core material and an adhesive layer covering a surface of the core material in a longitudinal direction.

[7] The composite according to any one of [1] to [6], in which the adhesive body is a pressure-sensitive adhesive body.

[8] The composite according to any one of [1] to [7], in which the electrically conductive threadlike member includes an electric wire or an electrically conductive fiber.

### Advantageous Effects of Invention

A composite according to the present invention has excellent adhesion strength and favorable electrical conductivity in a longitudinal direction of the composite and 360° in a circumferential direction (directions of a Y-axis and a Z-axis) with respect to the longitudinal direction as an axis (X-axis).

### BRIEF DESCRIPTION OF DRAWINGS

FIG. 1 is a schematic perspective view showing an embodiment of a composite according to an embodiment of the present invention.

FIG. 2 shows a modification of the embodiment of the composite according to the embodiment of the present invention.

FIG. 3 shows a modification of the embodiment of the composite according to the embodiment of the present invention.

FIG. 4 is a schematic cross-sectional view of an adhesive body provided in the composite according to the embodiment of the present invention.

FIG. 5A is a perspective view showing a method for evaluating adhesive strength of the composite according to the embodiment of the present invention.

FIG. 5B is a cross-sectional view of a cross-section taken along line A-A in FIG. 5A.

FIG. 6A is a perspective view showing a method for evaluating a resistance value in a Z-axis direction of the composite according to the embodiment of the present invention.

FIG. 6B is a cross-sectional view of a cross-section taken along line A-A in FIG. 6A.

### DESCRIPTION OF EMBODIMENTS

Hereinafter, an embodiment of the present invention will be described in detail. The present invention is not limited to the embodiment to be described below. In the following drawings, members, and parts having the same functions may be described with the same reference numerals, and duplicate descriptions may be omitted or simplified. The drawings of embodiments are schematically described for the purpose of clearly illustrating the present invention and do not necessarily accurately represent a size or scale of an actual product.

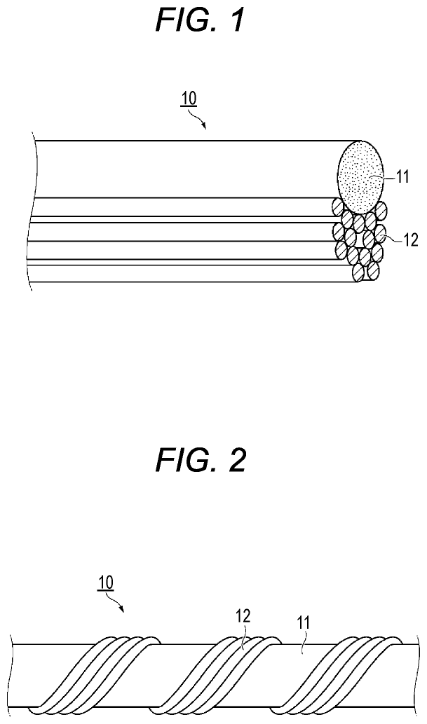

FIG. 1 is a schematic perspective view showing an embodiment of a composite according to the present invention.

A composite 10 according to the embodiment of the present invention includes an elongated adhesive body 11 and an electrically conductive threadlike member 12.

In the present specification, the term “elongated” refers to a shape in which a length in a predetermined direction (longitudinal direction) is sufficiently longer (for example, five times or more) than a length in another direction (for example, a width direction orthogonal to the longitudinal direction).

In the present specification, the term “threadlike” means a state of being elongated and further bendable in various directions and at various angles like a thread in addition to a linear shape, a curved shape, a broken-line shape, and the like.

In the present specification, an “X-axis direction” refers to a longitudinal direction of the composite, a “Y-axis direction” refers to a width direction of the composite, which is substantially orthogonal to the longitudinal direction, an “X-Y direction” refers to a plane direction including the X-axis and the Y-axis, and a “Z-axis direction” refers to a thickness direction of the composite, which is substantially orthogonal to the longitudinal direction and the Y-axis direction.

Since the elongated adhesive body 11 and the electrically conductive threadlike member 12 are provided, the composite 10 according to the embodiment of the present invention is superior in terms of the following points.

First, since the electrically conductive threadlike member (hereinafter, may be simply referred to as the threadlike member) is composited with the elongated adhesive body (hereinafter, may be simply referred to as the adhesive body), the composite 10 according to the embodiment of the present invention has excellent adhesive strength and can be used to fix the threadlike member 12 to an adherend. Further, the composite 10 can be used to bond members.

Since the adhesive body 11 is elongated and the electrically conductive member is threadlike, the composite can have an elongated shape, can be attached to a narrow member or in a narrow region, and can be easily applied to a complicated shape such as a curve, a curved surface, or unevenness.

Further, since the electrically conductive threadlike member obtained by forming an electrically conductive member into a threadlike shape is provided, the composite 10 has excellent electrical conductivity in the X-axis, Y-axis, and Z-axis directions.

In addition, in the composite according to the embodiment of the present invention, the electrically conductive threadlike member 12 may be spirally attached around the elongated adhesive body 11. In addition, the elongated adhesive body 11 may be spirally attached around the electrically conductive threadlike member 12.

From the viewpoint of electrical conductivity in the Z-axis direction, it is preferable that the electrically conductive threadlike member 12 is spirally attached around the elongated adhesive body 11 as shown in FIG. 2. That is, the composite according to the embodiment of the present invention is preferably a composite in which the electrically conductive threadlike member is spirally attached onto a surface of the adhesive body. In addition, it is preferable that the electrically conductive threadlike member is not covered in an insulated manner.

When the threadlike member 12 or the adhesive body 11 has a spiral shape, a bending property of the composite 10 is improved, thus the composite 10 can be more easily applied to a complicated shape such as a curve, a curved surface, or unevenness, and a structure followability thereof is improved. Further, when the threadlike member 12 has a spiral shape, excellent electrical conductivity is more easily exhibited in the X-axis, Y-axis, and Z-axis directions, that is, in the longitudinal direction of the composite and 360° in a circumferential direction (Y-axis, Z-axis) with respect to the longitudinal direction as an axis (X-axis).

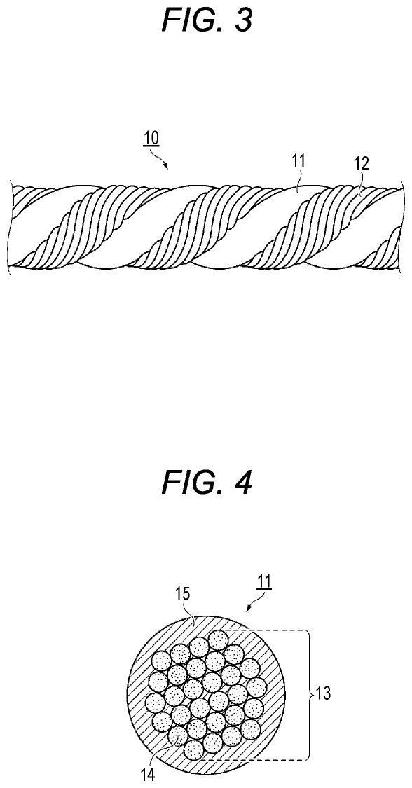

The composite 10 according to the embodiment of the present invention may be, for example, as shown in FIGS. 2 and 3, a composite in which the elongated adhesive body 11 and the electrically conductive threadlike member 12 are twisted together.

When the composite 10 is formed by twisting the elongated adhesive body 11 and the electrically conductive threadlike member 12 together, one or both of the threadlike member 12 and the adhesive body 11 may be formed into a spiral shape by adjusting hardness, elastic modulus, and the like of the adhesive body 11 and the threadlike member 12. When the threadlike member 12 and the adhesive body 11 are both formed in a spiral shape, the composite 10 can be more easily applied to a complicated shape such as a curve, a curved surface, or unevenness, and the structure followability thereof is improved. In addition, not only excellent structure followability and electrical conductivity in the X-axis, Y-axis, and Z-axis directions (the longitudinal direction and 360° in the circumferential direction of the composite) are exhibited, but also a ratio of the elongated adhesive body 11 exposed on a surface of the composite 10 to the electrically conductive threadlike member 12 is easily controlled, the adhesive body 11 is exposed on the surface of the composite 10 at equal intervals, and stable adhesive strength is easily obtained.

The threadlike member 12 in the composite 10 shown in FIG. 3 is obtained by twisting together (twisting into a yarn) a plurality of the threadlike members 12, and, as shown in FIG. 2, it is also possible to twist and composite a plurality of threadlike members 12 with the adhesive body 11 not by twisting the threadlike members 12 into a yarn.

In the composite 10 according to the embodiment of the present invention, the adhesive body may be threadlike and may include a threadlike core material and an adhesive layer covering a surface of the core material in a longitudinal direction. As will be described in detail later, the adhesive body is preferably a threadlike adhesive body. When the adhesive body is a threadlike adhesive body and the threadlike member is an electrically conductive thread, the composite 10 can be an electrically conductive threadlike adhesive body.

### <Electrically Conductive Threadlike Member>

The electrically conductive threadlike member 12 of the composite 10 according to the embodiment of the present invention is not particularly limited in thickness, length, cross-sectional shape, and the like as long as the threadlike member 12 is threadlike.

In addition, it is preferable that the electrically conductive threadlike member is not covered in an insulated manner. When the electrically conductive threadlike member is not covered in an insulated manner, excellent electrical conductivity is easily obtained not only in the longitudinal direction (X-axis direction) of the composite but also 360° in the circumferential direction (Y-axis direction and/or Z-axis direction).

The electrically conductive threadlike member 12 may be an electric wire, a thin metal wire, or an electrically conductive thread, preferably an electric wire or an electrically conductive thread, and more preferably an electrically conductive thread.

The electrically conductive thread preferably includes an electrically conductive fiber, and examples thereof include an electrically conductive fiber, a fiber bundle of electrically conductive fibers, and a twisted yarn, a braided yarn, a spun yarn, or a blended yarn using fibers including an electrically conductive fiber. In the present specification, the electrically conductive fiber, the fiber bundle of the electrically conductive fibers, and the twisted yarn, the braided yarn, the spun yarn, or the blended yarn using the fibers including the electrically conductive fiber may be collectively referred to as the electrically conductive fiber.

The electrically conductive threadlike member preferably includes an electric wire or an electrically conductive fiber.

The electrically conductive fiber may be any fiber as long as the fiber is electrically conductive, and may be, for example, a carbon fiber or a fiber obtained by blending carbon particles with metal particles, or may be a fiber containing an electrically conductive material such as a metal, an electrically conductive oxide, a carbon-based electrically conductive material (graphite, carbon, a carbon nanotube, or graphene), or an electrically conductive polymer, or may be a fiber covered with an electrically conductive material.

Among such electrically conductive fibers, the carbon fiber is preferable.

The fiber covered with the electrically conductive material may be a natural fiber or a chemical fiber.

The electrically conductive fiber is not particularly limited in a fiber shape thereof, and may be a long fiber (multifilament) or a short fiber.

The number of filaments in the electrically conductive fiber is appropriately selected according to use of the composite 10, and is preferably 1 or more, more preferably 10 or more, and still more preferably 20 or more from the viewpoint of stability of electrical conductivity in the Z axis direction derived from contact between the electrically conductive fiber and the adherend. In addition, the number of filaments is preferably 1000 or less, more preferably 500 or less, and still more preferably 100 or less from the viewpoint of preventing the electrically conductive fiber from covering an adhesive region during press-fitting.

A fiber diameter (monofilament diameter) of the electrically conductive fiber is preferably 1 μm or more, more preferably 5 μm or more, and still more preferably 10 μm or more from the viewpoint of fiber strength. In addition, the fiber diameter is preferably 1000 μm or less, more preferably 500 μm or less, and still more preferably 200 μm or less from the viewpoint that a large diameter prevents the adhesive region from being brought into contact with the adherend.

A total fineness and a single fiber fineness of the electrically conductive fiber are appropriately selected according to the use of the composite 10, the total fineness is preferably 20 dtex to 2000 dtex, and the single fiber fineness is preferably 0.5 dtex to 10.0 dtex.

The number of the threadlike members 12 used in the composite 10 according to the embodiment of the present invention may be plural, and an appropriate number can be selected according to a type of the threadlike member 12 and the use of the composite.

For example, a plurality of (for example, 2 to 40) threadlike members 12 may be composited with the elongated adhesive body 11 to form the composite 10.

For example, as shown in FIG. 1, the composite 10 according to the embodiment of the present invention may include a plurality of threadlike members 12 in a radial direction of the composite 10. In this case, the plurality of threadlike members 12 may be of the same type or different types. The number of the threadlike members 12 may be appropriately increased or decreased according to, for example, a diameter or an elastic modulus of the threadlike member 12.

A cross-sectional area of the threadlike member 12 in the present embodiment is not particularly limited, and it is possible to select a suitable area based on the number of the threadlike members 12 to be attached and the use. The cross-sectional area is preferably 3.0×10¹ μm² or more, more preferably 3.0×10² μm² or more, and still more preferably 3.0×10³ μm² from the viewpoint of reducing breakage risk and improving ease of handling. In addition, the cross-sectional area is preferably 3.0×10⁶ μm² or less, more preferably 3.0×10⁵ μm² or less, and still more preferably 1.0×10⁵ μm² or less not to cover the adhesive region of the adhesive body 11.

When the composite 10 includes a plurality of threadlike members 12 or when the threadlike member 12 is formed of a plurality of monofilaments, a total area of a plurality of cross-sectional areas is the cross-sectional area of the threadlike member 12.

The cross-sectional area of the threadlike member 12 can be obtained by measuring a monofilament diameter of the threadlike member 12 with a microscope, calculating a cross-sectional area by regarding a cross section of a monofilament as a circle, and multiplying the calculated cross-sectional area by the number of filaments.

A plurality of threadlike members 12 may be twisted together and composited with the adhesive body 11 to form the composite 10.

For example, as shown in FIG. 3, a plurality of threadlike members 12 may be twisted together and composited with the elongated adhesive body 11 to form the composite 10. In this case, the plurality of threadlike members 12 may also be of the same type or different types.

A normal method can be adopted for twisting the plurality of threadlike members 12 together. The number of twists when twisting the plurality of threadlike members 12 together may be 0 twist/m, and it is preferable that the threadlike members 12 in the present embodiment are twisted in order to impart cohesion to the threadlike members 12. Specifically, the number of twists of the threadlike members 12 in the present embodiment is preferably 1 twist/m or more, more preferably 5 twists/m or more, and still more preferably 10 twists/m or more. In addition, in order to prevent the threadlike members 12 from being excessively hard and being not deformed, the number of twists is preferably 1000 twists/m or less, more preferably 800 twists/m or less, and still more preferably 500 twists/m or less.

### <Adhesive Body>

The adhesive body 11 in the present embodiment is not particularly limited as long as the adhesive body 11 is elongated. A shape of a cross section perpendicular to a longitudinal direction of the adhesive body 11 in the present embodiment (hereinafter, also simply referred to as “cross-sectional shape”) is circular in FIG. 1, but is not limited thereto, and may be various shapes such as an elliptical shape, a polygonal shape such as a quadrangular shape, in addition to the circular shape.

A thickness of the adhesive body 11 in the present embodiment is not particularly limited, and a suitable thickness can be selected based on the number of the threadlike members 12 to be attached and the use.

A length of the adhesive body 11 in the present embodiment is also not particularly limited, and a suitable length can be selected based on the use.

The adhesive body 11 in the present embodiment is preferably threadlike. For example, even when the threadlike member 12 constituting the composite 10 is flexible (bendable), and deformation such as bending occurs in the composite 10, the threadlike adhesive body 11 can deform following the deformation.

A cross-sectional shape of the threadlike adhesive body 11 may not only be a circular shape, but also a short thread shape such as a quadrangular shape, or may be a star shape, an elliptical shape, a hollow shape, or the like.

A cross-sectional area of the adhesive body 11 in the present embodiment is not particularly limited, a suitable area can be selected based on the number of the threadlike members 12 to be attached and the use, and the cross-sectional area is preferably 7.5×10¹ μm² or more, more preferably 3.0×10⁴ μm² or more, and still more preferably 1.2×10⁵ μm² or more from the viewpoint of core material strength and from the viewpoint of ensuring a contact area with the adherend. In addition, the cross-sectional area is preferably 3.0×10⁶ μm² or less, more preferably 1.7×10⁶ μm² or less, and still more preferably 7.5×10⁵ μm² or less from the viewpoint of preventing a decrease in bendability caused by a large diameter.

When the composite 10 includes a plurality of adhesive bodies 11, a total cross-sectional area of a plurality of cross-sectional areas is defined as the cross-sectional area of the adhesive body 11. In a case where the adhesive body 11 includes the core material and the adhesive layer, the cross-sectional area of the adhesive body 11 is a total area of a cross-sectional area of the core material and a cross-sectional area of the adhesive layer.

The cross-sectional area of the adhesive body 11 can be obtained using a microscope by measuring a diameter of the adhesive body 11 and calculating by regarding a cross section of the adhesive body 11 as a circle.

In the composite 10 according to the present embodiment, a ratio of the cross-sectional area of the adhesive body 11 to the cross-sectional area of the threadlike member 12 (cross-sectional area of adhesive body 11/cross-sectional area of threadlike member 12) is preferably 1.0 or more, more preferably 2.0 or more, and still more preferably 4.0 or more from the viewpoint of ensuring the contact area between the adhesive body 11 and the adherend and obtaining certain or higher adhesion strength. In addition, the ratio is preferably 10000 or less, more preferably 1000 or less, and still more preferably 100 or less from the viewpoint of ensuring a contact area between the threadlike member 12 and the adherend and stably ensuring the electrical conductivity 360° in the circumferential direction (Y-axis and Z-axis directions).

The adhesive body 11 in the present embodiment may include the core material and a layer (adhesive layer) formed of an adhesive covering the core material. In addition, the adhesive body 11 may not include the core material and may include only the adhesive.

FIG. 4 is a cross-sectional view of a cross section perpendicular to the longitudinal direction of the adhesive body 11 according to the embodiment of the present invention. The adhesive body 11 according to the present embodiment includes a core material 13 and an adhesive layer 15 that covers a surface of the core material 13 in a longitudinal direction, and the core material 13 may be a multifilament yarn including a plurality of filaments 14.

Adhesive strength (difficulty in peeling off adherends from each other) when adherends are bonded to each other by the composite greatly depends on a contact area between the composite and the adherend.

When the adherends are bonded to each other using the composite 10 according to the present embodiment, the filaments 14 constituting the core material 13 spread in a releasing manner, and the core material 13 is deformed in a manner of being crushed. Accordingly, when the core material 13 in the present embodiment includes the plurality of filaments 14, a surface area is large, and thus an adhered amount of an adhesive per unit length can be increased.

In addition, when the core material 13 includes the plurality of filaments 14, the adhesive body 11 and the threadlike member 12 are easily twisted together, the ratio between the adhesive body 11 exposed on the surface of the composite 10 and the threadlike member 12 is easily made constant, the adhesive body 11 is easily exposed at equal intervals on the surface of the composite 10, and thus more stable adhesive strength is easily exhibited.

In order to obtain the above effect, the core material 13 is preferably a multifilament yarn including the plurality of filaments 14. In order to further improve the adhesive strength, the number of filaments 14 constituting the core material 13 in the present embodiment is preferably 10 or more, more preferably 15 or more, and still more preferably 20 or more. On the other hand, in a case where a thickness (fineness) of the core material 13 is kept at the same level, as the number of filaments 14 constituting the core material 13 increases, each filament becomes thinner (a fineness decreases). When each filament is excessively thin, strength of the core material 13 may be lowered and handleability may be deteriorated. Therefore, the number of filaments constituting the core material 13 is preferably 300 or less.

The core material 13 in the present embodiment may be a twisted yarn that is twisted, or may be a non-twisted yarn that is not twisted. That is, the number of twists of the core material 13 may be above 0 twist/m or may be 0 twist/m. In addition, the core material 13 may be a material in which a plurality of multifilaments, which are twisted yarns or non-twisted yarns, are bundled with being twisted or bundled without being twisted.

When a force is applied in a direction in which the adherends bonded to each other using the composite 10 according to the present embodiment are peeled from each other, the filaments 14 expand, and the core material 13 is deformed in a manner of extending in a direction parallel to the force applied in a thickness direction (a direction perpendicular to a longitudinal direction). However, when the shape of the core material 13 is excessively distorted at this time, stress is concentrated at a distorted part, and the part is likely to become a starting point of peeling. Therefore, in order to exhibit more excellent adhesive strength, it is preferable that the filaments 14 constituting the core material 13 have a certain degree of cohesion. As described above, the core material 13 in the present embodiment may be a non-twisted yarn or a twisted yarn, that is, the number of twists of the core material 13 in the present embodiment may be 0 twist/m or more, and in order to allow the filaments 14 constituting the core material 13 to have a certain degree of cohesion, it is preferable that the core material 13 in the present embodiment is twisted. Specifically, the number of twists of the core material 13 in the present embodiment is preferably 30 twists/m or more, more preferably 60 twists/m or more, and still more preferably 90 twists/m or more.

On the other hand, in order to sufficiently deform the core material 13 when the adherends are bonded to each other and to increase the adhered amount of the adhesive per unit length, it is preferable that the twisting of the core material 13 is not excessively strong. Therefore, the number of twists of the core material 13 is preferably 3000 twists/m or less, more preferably 1500 twists/m or less, still more preferably 800 twists/m or less, and particularly preferably 250 twists/m or less.

When the core material 13 is twisted, it is preferable that a twist coefficient represented by the following equation (A) is also controlled from the same viewpoint as described above. The twist coefficient is an index for discussing an influence of twisting (an influence on the cohesion of the core material, the ease of deformation, the adhered amount of the adhesive, and the like) regardless of the thickness of the core material. That is, the influence of the number of twists on the core material varies depending on the thickness of the core material, but if twist coefficients are the same, it is indicated that influences of twisting on the core material are the same regardless of the thickness of the core material.

The twist coefficient of the core material in the present embodiment is preferably 0 or more, and more preferably more than 0. On the other hand, when the twist coefficient is 200 or less, flexibility of the core material and the composite is improved, and thus the composite is easily attached to a complicated shape such as a curved portion, a bent portion, and an uneven portion or a narrow portion. Therefore, the twist coefficient of the core material is preferably 200 or less, more preferably 170 or less, still more preferably 100 or less, yet still more preferably 80 or less, and particularly preferably less than 50.

[Formula 1]

K=T/\sqrt{10000/D} (A)

In the equation (A), K represents a twist coefficient, T represents the number of twists (unit: [twist/m]), and D represents a fineness (unit: [dtex]).

In the present embodiment, a material of the filament 14 forming the core material 13 is not particularly limited and may be a chemical fiber or a natural fiber. Examples of the chemical fiber include various polymer materials such as rayon, cupra, acetate, promix, nylon, aramid, vinylon, vinylidene, polyvinyl chloride, polyester, acrylic, polyethylene, polypropylene, polyurethane, polychlal, and polylactic acid, glass, carbon fibers, synthetic rubber such as polyurethane, and metals. Examples of the natural fiber include silk and natural rubber.

From the viewpoint of adhesive strength, the filament 14 forming the core material 13 in the adhesive body 11 is preferably a chemical fiber. A chemical fiber is less likely to generate fluff and less likely to be distorted in shape. Therefore, when the filament forming the core material in the present embodiment is a chemical fiber, a starting point of peeling hardly occurs, and excellent adhesive strength is exhibited.

Among chemical fibers, polyester and nylon are particularly preferable.

The filament 14 forming the core material 13 in the adhesive body 11 may be a hollow filament. Since a hollow filament is typically rich in flexibility in a thickness direction and is easily deformed, the core material obtained by using the hollow filament is also rich in the flexibility in the thickness direction and is easily deformed.

Therefore, in the case where the hollow filament is used as the filament for forming the core material, the crushing deformation of the core material described above is more likely to occur. When the flexibility of the core material is high, generated stress is likely to disperse due to deformation of the core material when the force is applied in the direction in which the adherends bonded to each other using the composite are peeled off from each other. Therefore, stress is hardly applied to an interface (adhesive surface) between the composite and the adherend, and peeling is unlikely to occur. From the above points, when the hollow filament is used as the filament forming the core material, a composite having particularly excellent adhesive strength can be obtained.

Since the hollow filament is generally brittle, the hollow filament is preferably used without being twisted when the hollow filament is used as the filament for forming the core material.

The thickness (fineness) of the core material 13 in the adhesive body 11 is not particularly limited and may be appropriately adjusted according to the use of the composite and a type of the adherend. The fineness is, for example, 20 to 2000 dtex.

The core material 13 may contain various additives such as a filler (an inorganic filler, an organic filler, and the like), an anti-aging agent, an antioxidant, an ultraviolet absorber, an antistatic agent, a lubricant, a plasticizer, and a colorant (a pigment, a dye, and the like) as necessary. A known or common surface treatment such as a corona discharge treatment, a plasma treatment, or application of an undercoat agent may be performed on the surface of the core material.

The adhesive layer 15 in the adhesive body 11 is formed by the adhesive.

The adhesive constituting the adhesive layer 15 is not particularly limited, and a known adhesive can be used. Examples thereof include an acrylic adhesive, a rubber-based adhesive, a vinyl-alkyl-ether-based adhesive, a silicone-based adhesive, a polyester-based adhesive, a polyamide-based adhesive, a urethane-based adhesive, a fluorine-based adhesive, and an epoxy-based adhesive. Among these, the rubber-based adhesive and the acrylic adhesive are preferable, and the acrylic adhesive is particularly preferable from the viewpoint of adhesiveness. One type of the adhesives may be used alone, or two or more types thereof may be used in combination.

The acrylic adhesive contains, as a main component, a polymer of monomers that mainly contain a (meth)acrylic acid alkylester such as ethyl acrylate, butyl acrylate, 2-ethylhexyl acrylate, isooctyl acrylate, and isononyl acrylate, and is obtained by adding remodeling monomers, such as acrylonitrile, vinyl acetate, styrene, methyl methacrylate, (meth)acrylic acid, maleic anhydride, vinylpyrrolidone, glycidyl methacrylate, dimethylaminoethyl methacrylate, hydroxyethyl acrylate, and acrylamide, to the (meth)acrylic acid alkylester as necessary.

The rubber-based adhesive contains, as a main component, a rubber-based polymer such as natural rubber, a styrene-isoprene-styrene block copolymer, a styrene-butadiene-styrene block copolymer, a styrene-ethylene-butylene-styrene block copolymer, a styrene-butadiene rubber, polybutadiene, polyisoprene, polyisobutylene, butyl rubber, chloroprene rubber, and silicone rubber.

These adhesives may be appropriately blended with various additives such as an adhesive-imparting resin, for example, a rosin-based resin, a terpene-based resin, a styrene-based resin, an aliphatic petroleum-based resin, an aromatic petroleum-based resin, a xylene-based resin, a phenol-based resin, a coumarone-indene-based resin, and hydrogenated products thereof, a crosslinking agent, a viscosity modifier (a thickener and the like), a leveling agent, a release modifier, a plasticizer, a softener, a filler, a colorant (a pigment, a dye, and the like), a surfactant, an antistatic agent, a preservative, an anti-aging agent, an ultraviolet absorber, an antioxidant, and a light stabilizer.

As the adhesive, a solvent type adhesive or a water-dispersible type adhesive may be used. Here, the water-dispersible adhesive is preferable from the viewpoint of enabling high-speed coating, being environmentally friendly, and having a small influence (swelling or dissolving) on the core material due to a solvent.

The adhesive body 11 in the present embodiment may be a pressure-sensitive adhesive body or a hot melt adhesive, and is preferably the pressure-sensitive adhesive body. That is, the adhesive constituting the adhesive body 11 (adhesive layer 15) in the present embodiment is preferably a pressure-sensitive adhesive. The pressure-sensitive adhesive is an adhesive that has adhesiveness at room temperature and that can attach an adherend to a surface thereof by a pressure generated at the time of contact with the adherend, and is an adhesive that can be peeled and re-adhered. When the pressure-sensitive adhesive is used as the adhesive constituting the adhesive body 11, excellent workability is obtained when the composite is attached to the adherend. Further, for example, when the hot melt adhesive is used, heating is required when the threadlike member 12 is attached to the adhesive body 11, the threadlike member 12 may deteriorate at this time, and thus use of the pressure-sensitive adhesive is preferable since there is no risk of deterioration due to such heating.

In addition, in the case where the adhesive body 11 in the present embodiment includes the core material and the adhesive layer, a thickness of the adhesive layer is not particularly limited and may be appropriately determined according to a type of the adherend (article) to be attached and the use. For example, the thickness is preferably 3 μm or more and more preferably 5 μm or more from the viewpoint of adhesiveness. From the viewpoint of productivity, the thickness is preferably 500 μm or less and more preferably 100 μm or less.

In addition, the thickness (fineness) of the core material is not particularly limited and may be appropriately determined according to the type of the article to be attached and the use. For example, when a threadlike core material is used, the thickness is preferably, for example, 20 dtex or more, more preferably 25 dtex or more, and still more preferably 50 dtex or more from the viewpoint of strength. From the viewpoint of flexibility, the thickness is preferably, for example, 2000 dtex or less, more preferably 1500 dtex or less, and still more preferably 1000 dtex or less.

In order to further improve the adhesive strength of the composite 10 according to the present embodiment, it is preferable that a large amount of the adhesive is attached to the core material. Specifically, an adhered amount of the adhesive in the adhesive body 11 (a weight of the adhesive layer per unit length) is preferably 5 mg/m or more, more preferably 8 mg/m or more, and still more preferably 16 mg/m or more. On the other hand, when the adhered amount of the adhesive is excessive, it is necessary to apply the adhesive to the core material a plurality of times during a producing process, or it takes time to dry the applied adhesive, resulting in low production efficiency. Therefore, the adhered amount of the adhesive in the composite according to the present embodiment is preferably 200 mg/m or less, more preferably 180 mg/m or less, and still more preferably 160 mg/m or less.

In the adhesive body 11, the adhesive layer 15 may cover the entire surface (surface in the longitudinal direction) of the core material 13 or may cover only a part of the surface of the core material 13. The adhesive layer 15 is typically formed continuously, but is not limited to this form, and may be formed in a regular or random pattern such as a dot pattern or a stripe pattern. An end surface of the core material may or may not be covered with the adhesive layer 15. For example, when the adhesive body 11 is cut during a producing process or during use, the end surface of the core material 13 may not be covered with the adhesive layer 15.

An example of a method for producing the adhesive body 11 in the present embodiment will be described below. The method for producing the adhesive body 11 in the present embodiment is not limited to that described below.

The adhesive body 11 formed of only the adhesive without the core material can be obtained by, for example, preparing the adhesive constituting the adhesive body 11, linearly applying the adhesive with a dispenser onto a release liner, followed by heating and drying as necessary.

The adhesive body 11 including the core material and the adhesive layer can be obtained by, for example, coating an adhesive composition onto the surface of the core material by dipping, soaking, applying, or the like, followed by heating and drying as necessary. The adhesive composition can be applied by using a common coater such as a gravure roll coater, a reverse roll coater, a kiss roll coater, a dip roll coater, a bar coater, a knife coater, and a spray coater.

A temperature and a time of the drying are not particularly limited and may be set appropriately. The drying temperature is preferably 40° C. to 200° C., more preferably 50° C. to 180° C., and particularly preferably 70° C. to 120° C. The drying time is preferably 5 seconds to 20 minutes, more preferably 5 seconds to 10 minutes, and particularly preferably 10 seconds to 5 minutes.

### <Method for Producing Composite>

Hereinafter, an example of a method for producing the adhesive body 11 and the composite 10 according to the present embodiment will be described, but the production method is not limited to the following example.

The production method of the composite according to the embodiment of the present invention is not particularly limited, the elongated adhesive body and the electrically conductive threadlike member may be bundled, and the composite 10 may be obtained by bonding the threadlike member 12 to the adhesive body 11. At the time of attachment, an appropriate method can be adopted, such as, when the adhesive forming the adhesive body 11 is a pressure-sensitive adhesive, the threadlike member 12 is pressed against the adhesive body 11, and, when the adhesive is a hot melt adhesive, the threadlike member 12 is fixed to the adhesive body 11 and heated.

The elongated adhesive body may be used as the core material and the electrically conductive threadlike member may be wound around the core material, or the electrically conductive threadlike member may be used as the core material and the elongated adhesive body may be wound around the core material. The elongated adhesive body and the electrically conductive threadlike member may also be twisted together.

From the viewpoint of electrical conductivity in the Y-axis direction, it is preferable that the electrically conductive threadlike member is not drawn and aligned in the longitudinal direction. Therefore, it is preferable to wind the electrically conductive threadlike member around the elongated adhesive body as the core material or to twist the elongated adhesive body and the electrically conductive threadlike member together.

By twisting the adhesive body 11 and the threadlike member 12, the composite 10 exhibits better electrical conductivity in the X-axis, Y-axis, and Z-axis directions (the longitudinal direction and 360° in the circumferential direction of the composite) and the ratio of the adhesive body 11 to the threadlike member 12 can be easily made constant in any portion in the longitudinal direction. Then, the adhesive body 11 is exposed at equal intervals on the surface of the composite 10, and thus stable adhesive strength is easily exhibited.

The number of twists when twisting together the elongated adhesive body and the electrically conductive threadlike member may be 0 twist/m, but it is preferable that the composite according to the present embodiment is twisted from the viewpoint described above. Specifically, the number of twists of the composite according to the present embodiment is preferably 1 twist/m or more, more preferably 10 twists/m or more, and still more preferably 20 twists/m or more. From the viewpoint of preventing bendability from decreasing due to excessive twisting, the number of twists is preferably 1000 twists/m or less, more preferably 500 twists/m or less, and still more preferably 300 twists/m or less.

The composite 10 according to the present embodiment is preferable since the composite 10 has good electrical conductivity in the X-axis, Y-axis, and Z-axis directions (the longitudinal direction and 360° in the circumferential direction of the composite), can be attached to a narrow member or a narrow region, and can be easily applied to a complicated shape such as a curve, a curved surface, and unevenness. Further, the composite 10 has excellent adhesive strength and thus can be used for adhesion of various articles.

For example, the composite 10 according to the present embodiment can be suitably used for fixing an article during production of an electronic device and can be applied for fixing an electrically conductive threadlike member.

Specifically, the composite 10 according to the present embodiment can be suitably used for fixing, in a desired form, various types of wire materials such as an electric wire, an electrically conductive fiber, and a wire, and electrically conductive threadlike members such as a narrow article. Even when the wire material or the narrow threadlike member is fixed to another article in a complicated shape, the composite 10 according to the present embodiment can firmly fix with excellent workability according to the complicated shape of the wire material or the narrow article, while preventing protrusions, wrinkles, and overlaps.

### EXAMPLE

Hereinafter, the present invention will be described in detail with reference to Examples, but the present invention is not limited to these Examples.

### Example 1

### (Preparation of Coating Liquid 1)

Into a reaction vessel equipped with a cooling tube, a nitrogen introduction tube, a thermometer, and a stirrer, 40 parts by mass of ion-exchanged water was added, and stirring was performed at 60° C. for 1 hour or more while introducing nitrogen gas to carry out nitrogen substitution. To this reaction vessel, 0.1 parts by mass of 2,2′-azobis[N-(2-carboxyethyl)-2-methylpropionamidine]n hydrate (polymerization initiator) was added. While the system was maintained at 60° C., a monomer emulsion A to be described below was gradually added dropwise thereto over 4 hours to allow an emulsion polymerization reaction to proceed.

Examples of the monomer emulsion A include an emulsion obtained by adding 98 parts by mass of 2-ethylhexyl acrylate, 1.25 parts by mass of acrylic acid, 0.75 parts by mass of methacrylic acid, 0.05 parts by mass of lauryl mercaptan (chain transfer agent), 0.02 parts by mass of 7-methacryloxypropyltrimethoxysilane (manufactured by Shin-Etsu Chemical Co., Ltd., trade name: “KBM-503”), and 2 parts by mass of sodium polyoxyethylene lauryl sulfate (emulsifier) to 30 parts by mass of ion-exchanged water.

After completion of the dropwise addition of the monomer emulsion A, the system was further kept at 60° C. for 3 hours and cooled to room temperature, and pH was then adjusted to 7 by addition of 10% ammonia water to obtain an acrylic polymer emulsion (water-dispersible acrylic polymer).

An adhesive-imparting resin emulsion (manufactured by Arakawa Chemical Industries, Ltd., trade name: “E-865NT”) was added in an amount of 24 parts by mass based on the solid content per 100 parts by mass of the acrylic polymer contained in the above acrylic polymer emulsion. Further, ion-exchanged water was added to adjust a solid content concentration to 50 mass % to obtain a coating liquid 1.

### (Production of Threadlike Adhesive Body)

A multifilament yarn in which seven polyester fibers (167T48f×7) having a fineness of 167 dtex and 48 filaments were twisted 70 times per meter was prepared as a core material.

The core material was coated with the coating liquid 1 by dipping using a coating roller rotating at the same speed as a feed rate. Thereafter, the core material was dried at 100° C. for 4 minutes to obtain a threadlike adhesive body having a diameter (a width in a short direction) of 450 μm.

### (Production of Electrically Conductive Threadlike Adhesive Body)

A copper-sulfide-coated nylon fiber having a fineness of 235 dtex and 15 filaments (trade name: “Thunderon (registered trademark)” manufactured by Nihon Sanmo Dyeing Co., Ltd.) was bonded as an electrically conductive fiber to the threadlike adhesive body prepared by the above production method to obtain an electrically conductive threadlike adhesive body.

### Example 2

### (Production of Electrically Conductive Threadlike Adhesive Body)

The threadlike adhesive body used in Example 1 and a copper-sulfide-coated nylon fiber having a fineness of 235 dtex and 15 filaments as an electrically conductive fiber were prepared.

The threadlike adhesive body and the electrically conductive fiber were twisted 30 times per meter with a twisting machine (manufactured by Olympus Thread Manufacturing Co., Ltd., trade name “String-II high-speed braid maker”) to obtain an electrically conductive threadlike adhesive body.

### Example 3

An electrically conductive threadlike adhesive body was obtained in the same manner as in Example 2 except that a two-ply yarn of copper-sulfide-coated nylon fibers each having a fineness of 235 dtex and 15 filaments was used as the electrically conductive fiber.

### Example 4

An electrically conductive threadlike adhesive body was obtained in the same manner as in Example 2 except that a four-ply yarn of copper-sulfide-coated nylon fibers each having a fineness of 235 dtex and 15 filaments was used as the electrically conductive fiber.

### Example 5

An electrically conductive threadlike adhesive body was obtained in the same manner as in Example 2 except that the threadlike adhesive body and the electrically conductive fiber were twisted 60 times per meter with the twisting machine.

### Example 6

An electrically conductive threadlike adhesive body was obtained in the same manner as in Example 2 except that a fiber obtained by additionally twisting the copper-sulfide-coated nylon fiber having a fineness of 235 dtex and 15 filaments 50 times per meter was used as the electrically conductive fiber.

### Example 7

An electrically conductive threadlike adhesive body was obtained in the same manner as in Example 2 except that a fiber obtained by additionally twisting the copper-sulfide-coated nylon fiber having a fineness of 235 dtex and 15 filaments 300 times per meter was used as the electrically conductive fiber.

### Example 8

An electrically conductive threadlike adhesive body was obtained in the same manner as in Example 2 except that a copper-sulfide-coated nylon fiber having a fineness of 234 dtex and 72 filaments (trade name “Thunderon (registered trademark)” manufactured by Nihon Sanmo Dyeing Co., Ltd.) was used as the electrically conductive fiber.

### Example 9

An electrically conductive threadlike adhesive body was obtained in the same manner as in Example 2 except that a fiber obtained by additionally twisting a copper-sulfide-coated nylon fiber having a fineness of 234 dtex and 72 filaments 300 times per meter was used as the electrically conductive fiber.

### Comparative Example 1

The threadlike adhesive body described in Example 1 was used.

### <Pressing Adhesive Strength>

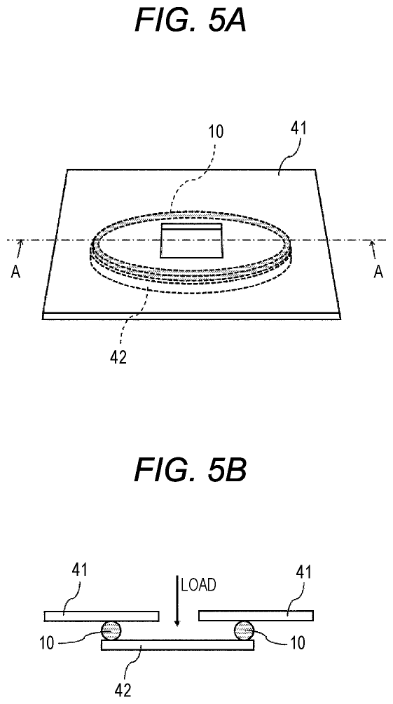

Using 22 cm of each electrically conductive threadlike adhesive body, a circular acrylic plate 42 having a thickness of 3 mm and a diameter of 70 mm and a rectangular polycarbonate resin plate 41 (short side: 80 mm, long side: 110 mm, thickness: 10 mm) provided with a rectangular slit (short side: 30 mm, long side: 40 mm) in a central portion thereof were bonded to each other such that a center of the acrylic plate 42 and a center of the slit in the polycarbonate resin plate 41 coincide with each other. Thereafter, the bonded sample was press-bonded at a pressure corresponding to 0.3 MPa for 20 seconds. The electrically conductive threadlike adhesive body (composite 10) was disposed along an edge of the acrylic plate as shown in FIG. 5A and FIG. 5B. A perspective view of the bonded state is shown in FIG. 5A, and a cross-sectional view taken along line A-A in FIG. 5A is shown in FIG. 5B.

Next, the polycarbonate resin plate 41 was fixed, and as shown in FIG. 5B, a load was applied to the center of the acrylic plate 42 through the slit in a direction in which the acrylic plate 42 and the polycarbonate resin plate 41 were away from each other, and a maximum load observed before the acrylic plate 42 and the polycarbonate resin plate 41 were separated from each other was measured, thereby obtaining pressing adhesive strength (N/22 cm).

### <Resistance Value in Longitudinal Direction of Electrically Conductive Threadlike Adhesive Body>

The electrically conductive threadlike adhesive body was fixed to a clip-type terminal over a distance of 100 mm.

A resistance value was calculated based on a flowing current when a voltage of 0.5 V is applied as a resistance value in a longitudinal direction (X-axis direction) of the electrically conductive threadlike adhesive body.

### <Resistance Value in Z-Axis Direction>

First, two copper foil plates of 25 mm×40 mm were prepared.

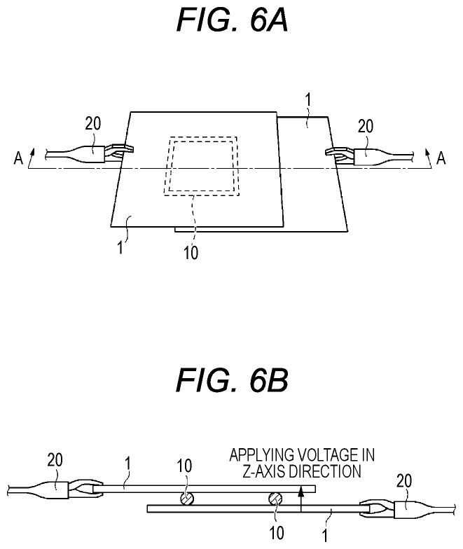

As shown in FIG. 6A and FIG. 6B, 100 mm of the electrically conductive threadlike adhesive body (composite 10) was attached to one of the copper foil plates (copper foil plate 1) in a square shape having a side of 25 mm. Thereafter, the other copper foil plate 1 was bonded and press-bonded at a pressure corresponding to 0.3 MPa for 20 seconds.

Twenty minutes after the press-bonding, clip-type terminals 20 were connected to both ends of the bonded copper foil plates, a voltage of 0.5 V was applied, and a flowing current was measured to obtain a resistance value in a thickness direction (Z-axis direction) substantially orthogonal to the longitudinal direction of the composite. A perspective view of a state in which the two copper foil plates are bonded is shown in FIG. 6A, and a cross-sectional view taken along line A-A in FIG. 6A is shown in FIG. 6B.

### <Cross-Sectional Areas of Adhesive Body and Threadlike Member>

### (Cross-Sectional Area of Adhesive Body)

A diameter of each threadlike adhesive body (adhesive body) used in Examples and Comparative Examples was measured with a microscope (digital microscope, trade name “VHX-7000”, manufactured by KEYENCE Corporation), and a cross-sectional area was calculated by regarding a cross section of each adhesive body as a circle.

### (Cross-Sectional Area of Threadlike Member)

A monofilament diameter of each electrically conductive fiber (threadlike member) used in Examples and Comparative Examples was measured with a microscope. Based on this value, a cross section of a monofilament was regarded as a circle to calculate a cross-sectional area and multiplied by the number of filaments to calculate a cross-sectional area of each threadlike member.

A ratio between the cross-sectional area of the adhesive body and the cross-sectional area of the threadlike member was calculated based on the obtained cross-sectional areas of the adhesive body and the threadlike member.

Results obtained in Examples and Comparative Examples are shown in Table 1.

TABLE 1

| | | | Electrically conductive fiber | | | | |
|---|---|---|---|---|---|---|---|
| | Threadlike adhesive body | | | | | Number of | (Approx) |
| | | (Approx.) | | | Number | additional | monofilament |
| | | diameter | | | of | twists | diameter |
| Sample | Type | [μm] | Type | Fineness | filaments | [twists/m] | [μm] |
| Example 1 | 167T48f × 7 | 450 | Copper-sulfide- | 235 | 15 | 0 | 40 |
| | | | coating nylon | | | | |
| Example 2 | 167T48f × 7 | 450 | Copper-sulfide- | 235 | 15 | 0 | 40 |
| | | | coating nylon | | | | |
| Example 3 | 167T48f × 7 | 450 | Copper-sulfide- | 470 | 30 | 0 | 40 |
| | | | coating nylon | | | | |
| Example 4 | 167T48f × 7 | 450 | Copper-sulfide- | 940 | 60 | 0 | 40 |
| | | | coating nylon | | | | |
| Example 5 | 167T48f × 7 | 450 | Copper-sulfide- | 235 | 15 | 0 | 40 |
| | | | coating nylon | | | | |
| Example 6 | 167T48f × 7 | 450 | Copper-sulfide- | 235 | 15 | 50 | 40 |
| | | | coating nylon | | | | |
| Example 7 | 167T48f × 7 | 450 | Copper-sulfide- | 235 | 15 | 300 | 40 |
| | | | coating nylon | | | | |
| Example 8 | 167T48f × 7 | 450 | Copper-sulfide- | 234 | 72 | 0 | 20 |
| | | | coating nylon | | | | |
| Example 9 | 167T48f × 7 | 450 | Copper-sulfide- | 234 | 72 | 300 | 20 |
| | | | coating nylon | | | | |
| Comparative | 167T48f × 7 | 450 | — | — | — | — | — |
| Example 1 | | | | | | | |

| | | Adhesive body | | | |
|---|---|---|---|---|---|
| | | cross-sectional | Pressing | | |
| | Number | area/threadlike | adhesive | Resistance value | |
| | of twists | member cross- | strength | X-axis | Z-axis |
| Sample | [twists/m] | sectional area | [N/22 cm] | direction | direction |
| Example 1 | 0 | 8.4 | 8.8 | 2.4E+03 | 1.8E+04 |
| Example 2 | 30 | 8.4 | 31.2 | 2.8E+03 | 3.4E+03 |
| Example 3 | 30 | 4.2 | 23.6 | 1.0E+03 | 1.0E+03 |
| Example 4 | 30 | 2.1 | 6.4 | 4.1E+02 | 6.7E+02 |
| Example 5 | 60 | 8.4 | 25.4 | 4.0E+03 | 7.7E+02 |
| Example 6 | 30 | 8.4 | 33.5 | 1.4E+03 | 1.7E+03 |
| Example 7 | 30 | 8.4 | 23.1 | 2.0E+03 | 5.8E+02 |
| Example 8 | 30 | 7.0 | 21.3 | 8.6E+02 | 1.1E+04 |
| Example 9 | 30 | 7.0 | 26.8 | 5.8E+02 | 1.3E+03 |
| Comparative | — | — | 37.5 | Insulated | Insulated |
| Example 1 | | | | | |

Since the elongated adhesive body and the electrically conductive threadlike member are provided, the composite according to the present invention exhibits excellent adhesion strength and favorable electrical conductivity.

### INDUSTRIAL APPLICABILITY

A composite according to the present invention has excellent adhesion strength and favorable electrical conductivity in a longitudinal direction of the composite and 360° in a circumferential direction (directions of a Y-axis and a Z-axis) with respect to the longitudinal direction as an axis (X-axis).

While the present invention has been described in detail with reference to specific embodiments, it will be apparent to those skilled in the art that various changes and modifications can be made without departing from the spirit and scope of the present invention.

### REFERENCE SIGNS LIST

1 copper foil plate
10 composite
11 adhesive body
12 threadlike member
13 core material
14 filament
15 adhesive layer
20 clip-type terminal
41 polycarbonate resin plate
42 acrylic plate

1. A composite, comprising:
an elongated adhesive body; and
an electrically conductive threadlike member.

2. The composite according to claim 1, wherein
the electrically conductive threadlike member is not covered in an insulated manner.

3. The composite according to claim 1, wherein
the electrically conductive threadlike member is spirally attached onto a surface of the adhesive body.

4. The composite according to claim 1, wherein
the adhesive body and the electrically conductive threadlike member are twisted together.

5. The composite according to claim 1, wherein
the adhesive body is threadlike.

6. The composite according to claim 1, wherein
the adhesive body comprises a threadlike core material and an adhesive layer covering a surface of the core material in a longitudinal direction.

7. The composite according to claim 1, wherein
the adhesive body is a pressure-sensitive adhesive body.

8. The composite according to claim 1, wherein
the electrically conductive threadlike member comprises an electric wire or an electrically conductive fiber.
